(19) United States
(12) Patent Application Publication
(10) Pub. No.: US 2005/0171939 A1
(43) Pub. Date: Aug. 4, 2005

(54) Methods and apparatuses for synchronizing and identifying content

(76) Inventors: Clay Fisher, San Diego, CA (US); Jeff Goldstein, Westwood, NJ (US); Neal Manowitz, Montebello, NY (US)

Correspondence Address: Valley Oak Law, 5655 Silver Creek Valley Road, # 106, San Jose, CA, 95138, US

(21) Appl. No.: 10/771,815

(22) Filed: Feb. 4, 2004

(51) Int. Cl. G06F 17/30

(52) U.S. Cl. 707/3

(57) ABSTRACT

In one embodiment, the methods and apparatuses for synchronizing and identifying content receive a request for a specific content from a first device; identify the specific content within a second device; select a format for the specific content based on the first device; and transmit the specific content in the format from the second device to the first device.

### FIELD OF THE INVENTION

The present invention relates generally to synchronizing and identifying content and, more particularly, to synchronizing and identifying content based on a device.

### BACKGROUND

There has been a proliferation of content utilized by users. This content typically includes documents, audio tracks, video tracks, graphic images, and photographs. In many instances, the content utilized by a user is stored within multiple devices such as computers, personal digital assistants, cellular phones, portable audio players, and digital cameras.

Managing this increasing amount of content is a challenge for many users. For example, duplicates of the same content may exist without an effective way of being aware that duplicates exist. Additionally, multiple versions of related content may exist without the user being aware of related content.

Further, managing content across multiple devices is also a challenge for many users. For example, the user that has content stored across multiple devices typically cannot effectively manage or synchronize the content.

In many cases, users want help in organizing, synchronizing, and protecting their content.

### SUMMARY

In one embodiment, the methods and apparatuses for synchronizing and identifying content receive a request for a specific content from a first device; identify the specific content within a second device; select a format for the specific content based on the first device; and transmit the specific content in the format from the second device to the first device.

### BRIEF DESCRIPTION OF THE DRAWINGS

The accompanying drawings, which are incorporated in and constitute a part of this specification, illustrate and explain one embodiment of the methods and apparatuses for synchronizing and identifying content. In the drawings,

FIG. 1 is a diagram illustrating an environment within which the methods and apparatuses for synchronizing and identifying content are implemented;

FIG. 2 is a simplified block diagram illustrating one embodiment in which the methods and apparatuses for synchronizing and identifying content are implemented;

FIG. 3 is a simplified block diagram illustrating a system, consistent with one embodiment of the methods and apparatuses for synchronizing and identifying content;

FIG. 4 is an exemplary record for use with the methods and apparatuses for synchronizing and identifying content;

FIG. 5 is a flow diagram consistent with one embodiment of the methods and apparatuses for synchronizing and identifying content;

FIG. 6 is a flow diagram consistent with one embodiment of the methods and apparatuses for synchronizing and identifying content;

FIG. 7 is a flow diagram consistent with one embodiment of the methods and apparatuses for synchronizing and identifying content;

FIG. 8 is a flow diagram consistent with one embodiment of the methods and apparatuses for synchronizing and identifying content; and

FIG. 9 is a flow diagram consistent with one embodiment of the methods and apparatuses for synchronizing and identifying content.

### DETAILED DESCRIPTION

The following detailed description of the methods and apparatuses for synchronizing and identifying content refers to the accompanying drawings. The detailed description is not intended to limit the methods and apparatuses for synchronizing and identifying content. Instead, the scope of the methods and apparatuses for synchronizing and identifying content is defined by the appended claims and equivalents. Those skilled in the art will recognize that many other implementations are possible, consistent with the present invention.

References to “content” includes data such as video, audio, and the like, that are embodied in digital or analog electronic form.

References to “electronic device” includes a device such as a portable audio device (e.g. a portable MP3 player, a Walkman, a personal digital assistant), a stationary audio device (e.g. an audio server, a digital audio player, a computer), and an audio/visual device (e.g. a DVD player, a DVD recorder, an audio/video server, a digital video recorder, a computer).

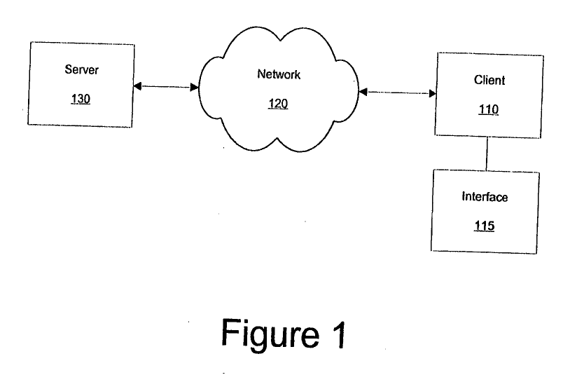

FIG. 1 is a diagram illustrating an environment within which the methods and apparatuses for synchronizing and identifying content are implemented. The environment includes an electronic device 110 (e.g., a computing platform configured to act as a client device, such as a computer, a personal digital assistant, a portable MP3 player), a user interface 115, a network 120 (e.g., a local area network, a home network, the Internet), and a server 130 (e.g., a computing platform configured to act as a server).

In one embodiment, one or more user interface 115 components are made integral with the electronic device 110 (e.g., keypad and video display screen input and output interfaces in the same housing as personal digital assistant electronics (e.g., as in a Clie® manufactured by Sony Corporation). In other embodiments, one or more user interface 115 components (e.g., a keyboard, a pointing device (mouse, trackball, etc.), a microphone, a speaker, a display, a camera) are physically separate from, and are conventionally coupled to, electronic device 110. The user utilizes interface 115 to access and control content and applications stored in electronic device 110, server 130, or a remote storage device (not shown) coupled via network 120.

In accordance with the invention, embodiments of synchronizing and identifying content as described below are executed by an electronic processor in electronic device 110, in server 130, or by processors in electronic device 110 and in server 130 acting together. Server 130 is illustrated in FIG. 1 as being a single computing platform, but in other instances are two or more interconnected computing platforms that act as a server.

The methods and apparatuses for synchronizing and identifying content are shown in the context of exemplary embodiments of applications in which content is synchronized and tracked for a device. In one embodiment, the content is utilized through the electronic device 110 and the network 120. In another embodiment, the content is tracked and synchronized by the application which is located within the server 130 and/or the electronic device 110.

In one embodiment, the methods and apparatuses for synchronizing and identifying content automatically creates a record associated with an individual content. In one instance, information within the record is automatically completed by the methods and apparatuses for synchronizing and identifying content based on previously stored records associated with corresponding content.

In one embodiment, a request by a device to utilize content is fulfilled by searching for the content in possibly multiple devices. In another embodiment, the request to utilize content is fulfilled by identifying an appropriate format for he content based on the device.

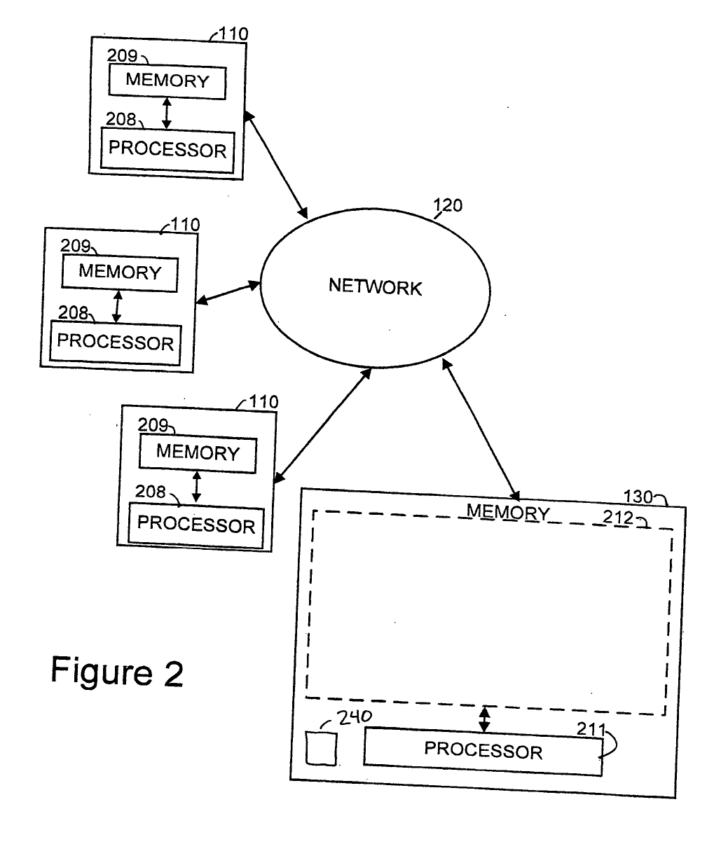

FIG. 2 is a simplified diagram illustrating an exemplary architecture in which the methods and apparatuses for synchronizing and identifying content are implemented. The exemplary architecture includes a plurality of electronic devices 110, a server device 130, and a network 120 connecting electronic devices 110 to server 130 and each electronic device 110 to each other. The plurality of electronic devices 110 are each configured to include a computer-readable medium 209, such as random access memory, coupled to an electronic processor 208. Processor 208 executes program instructions stored in the computer-readable medium 209. A unique user operates each electronic device 110 via an interface 115 as described with reference to FIG. 1.

Server device 130 includes a processor 211 coupled to a computer-readable medium 212. In one embodiment, the server device 130 is coupled to one or more additional external or internal devices, such as, without limitation, a secondary data storage element, such as database 240.

In one instance, processors 208 and 211 are manufactured by Intel Corporation, of Santa Clara, Calif. In other instances, other microprocessors are used.

The plurality of client devices 110 and the server 130 include instructions for a customized application synchronizing and identifying content. In one embodiment, the plurality of computer-readable medium 209 and 212 contain, in part, the customized application. Additionally, the plurality of client devices 110 and the server 130 are configured to receive and transmit electronic messages for use with the customized application. Similarly, the network 120 is configured to transmit electronic messages for use with the customized application.

One or more user applications are stored in memories 209, in memory 211, or a single user application is stored in part in one memory 209 and in part in memory 211. In one instance, a stored user application, regardless of storage location, is made customizable based on synchronizing and identifying content as determined using embodiments described below.

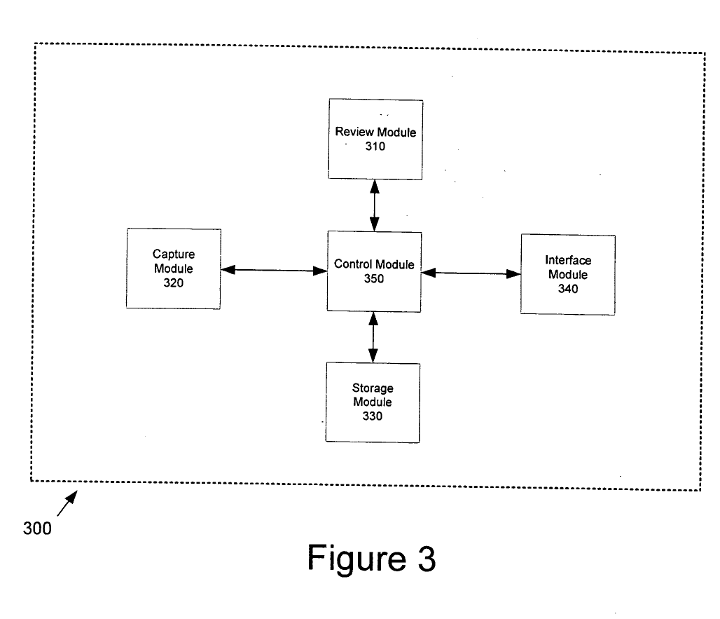

FIG. 3 illustrates one embodiment of a synchronizing and identifying system 300. In one embodiment, the system 300 is embodied within the server 130. In another embodiment, the system 300 is embodied within both the electronic device 110 and the server 130.

In one embodiment, the system 300 includes a review module 310, a capture module 320, a storage module 330, an interface module 340, and a control module 350.

In one embodiment, the control module 350 communicates with the review module 310, the capture module 320, the storage module 330, and the interface module 340. In one embodiment, the control module 350 coordinates tasks, requests, and communications between the review module 310, the capture module 320, the storage module 330, and the interface module 340.

In one embodiment, the review module 310 analyzes content and a record associated with the content via the capture module 320. In one embodiment, the review module 310 is configured to analyze the content and the associated record based on specific functions. One example of a specific function is to recognize duplicate content. Another example of a specific function is to remove duplicate copies.

In another embodiment, the review module 310 creates a record for a new content based on the characteristics of the new content. In one instance, the review module 310 analyzes the new content in light of other content and their associated records to automatically complete the fields within the record of the new content.

In yet another embodiment, the review module 310 updates an existing record based on other content and their associated records. In one instance, the review module 310 analyzes the record corresponding to the existing content in light of new content and their associated records to automatically update the fields within the existing record of the existing content.

In one embodiment, the capture module 320 identifies specific content and associated record for use by the system 300. In one embodiment, the capture module 320 detects content that is within an electronic device 110 that is identified the user. In addition, the capture module 320 supplies content and associated record to the review module 310. In one embodiment, the content detected by the capture module 320 spans multiple electronic devices 110. For example, the electronic device 110 includes a personal digital assistant, a computer, an audio media player, and the like.

In one embodiment, the storage module 330 stores a record associated with content. In another embodiment, the storage module 330 also stores the content that is associated with the record.

In one embodiment, the interface module 340 receives a request for a specific function from one of the electronic devices 110. For example, in one instance, the electronic device requests content from another device through the system 300.

In another embodiment, the interface module 340 displays information contained within the record associated with the content.

The synchronizing and tracking system 300 in FIG. 3 is shown for exemplary purposes and is merely one embodiment of the methods and apparatuses for synchronizing and tracking content. Additional modules may be added to the system 300 without departing from the scope of the methods and apparatuses for sequestering content. Similarly, modules may be combined or deleted without departing from the scope of the methods and apparatuses for synchronizing and tracking content.

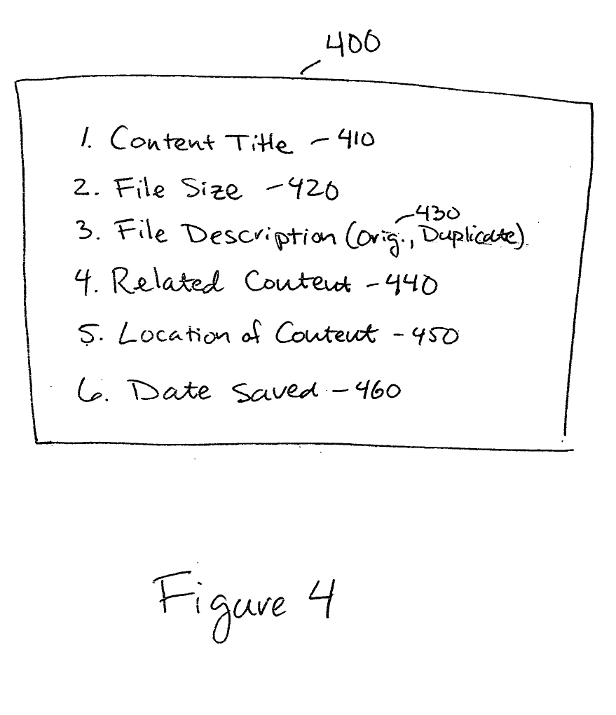

FIG. 4 illustrates an exemplary record 400 for use with the system 300. The record 400 is associated with a specific content. In some embodiments, the record 400 includes a content identification field 410, a file size field 420, a file description field 430, a related content field 440, a location of content field 450, and a date saved field.

In one embodiment, the content identification field 410 identifies the content. In one instance, the content description field 410 includes a descriptive title for the content. In another instance, the content field 410 includes a unique identification that corresponds to the content.

In one embodiment, the file size field 420 indicates the file size of the content.

In one embodiment, the file description field 430 describes the nature of the content. In some instances, the file description field 430 identifies that the content is an original content, a modified content, a duplicate content, a copyrighted content, and the like.

In one embodiment, the related content field 440 indicates other content that is related to the content associated with the record 400. For example, a duplicate content to the content associated with the record 400 is indicated within the related content field 440.

In one embodiment, the location of content field 450 indicates the location that the content is stored.

In one embodiment, the date saved field 460 indicates the last time that the content was saved. In one embodiment, the date saved field is utilized to determine the original content compared with copies of the original content.

In one embodiment, additional fields include length of individual tracks, an artist field, a genre field, and a format field.

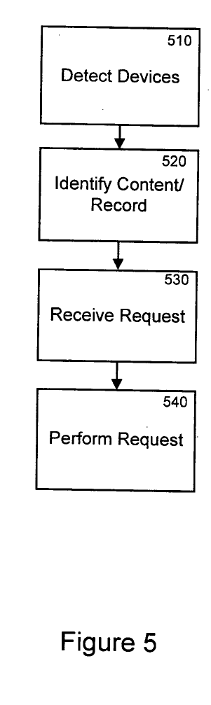

The flow diagrams as depicted in FIGS. 5, 6, 7, 8, and 9 are one embodiment of the methods and apparatuses for synchronizing and tracking content. The blocks within the flow diagrams can be performed in a different sequence without departing from the spirit of the methods and apparatuses for synchronizing and tracking content. Further, blocks can be deleted, added, or combined without departing from the spirit of the methods and apparatuses for synchronizing and tracking content.

The flow diagram in FIG. 5 illustrates synchronizing and tracking content according to one embodiment of the invention. In Block 510, devices that are identified are detected. In one embodiment, each of the devices contains content. In one instance, one of the devices is a content player such as a portable audio player, a video player, and the like. In another instance, one of the devices is a media server configured to store and stream content.

In Block 520, content stored within each of the devices identified in the Block 510 are identified in one embodiment. In another embodiment, the record associated with each piece of content is also identified. In one instance, the record includes information illustrated in the record 400.

In one embodiment, the content is an audio content such as a song, music, and the like. In another embodiment, the content is audio/visual content such as video footage.

In Block 530, a request is received from one of the devices. In one embodiment, the request includes playing, loading, synchronizing, storing, deleting, copying, or modifying the content.

In Block 540, the request is performed based on the request in the Block 530. In one embodiment, the request is performed based on the content and the corresponding record. For example, duplicate content is identified by the records associated with the content. In another embodiment, the request is performed based on the characteristics of the device. For example, if the device has limited storage capabilities, the content is stored within the device at a more compressed format to conserve storage capacity.

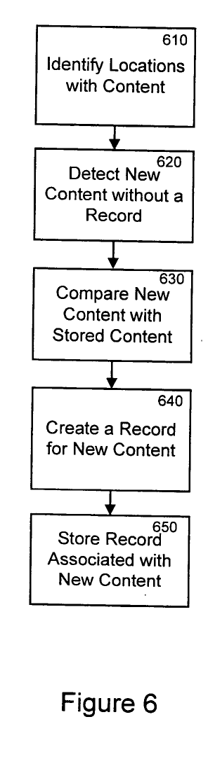

The flow diagram in FIG. 6 illustrates creating a record for new content according to one embodiment of the invention. In Block 610, electronic devices that store content are identified. In one embodiment, the particular electronic devices are identified by the user. In one embodiment, the electronic device is an audio player, a video player, a computer, and the like.

In Block 620, content without a record is detected. In one embodiment, content that does not have an associated record is considered “new” content to the system.

In Block 630, new content without a record is compared with existing content having a corresponding record. In one embodiment, the new content is compared with the existing content. If the new content is similar or identical to the existing content, this information is utilized in creating a record corresponding to the new content in one embodiment.

In one embodiment, the new content is compared with the existing content via an analysis of the actual content. For instance, if the new content is an audio clip, the audio clip of the new content is compared against the audio clip of existing content via an audio analyzer. In another embodiment, the file size of the new content is compared with the file size of the existing content to compare the similarities between the new content and the existing content.

In Block 640, a record corresponding to the new content is created. In some embodiments, the record is similar to the record 400 shown in FIG. 4. In some embodiments, the record corresponding to the new content is automatically completed based on the information contained within the new content and the comparison between the new content and the existing content. For example, if there are duplicate or related content found by comparing the new content to the existing content, the record of the new content is reflected within the file description field 430 and the related content field 440.

In Block 650, the record corresponding to the new content is stored. In some embodiments, the record is stored within the storage module 330.

In Block 660, records corresponding to existing content is updated based on the record of the new content. For example, if there are duplicate or related content found by comparing the new content to the existing content, records of the existing content are updated within the file description field 430 and the related content field 440.

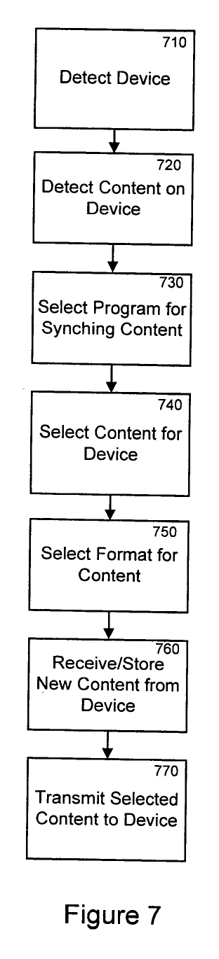

The flow diagram in FIG. 7 illustrates synchronizing and tracking content according to one embodiment of the invention. In Block 710, a particular device that is requesting a synchronization with a second device is detected. In one embodiment, the particular device and the second device both contain content. In one instance, the particular device is a content player such as a portable audio player, a video player, and the like. In one instance, the second device is a media server configured to store and stream content.

In Block 720, the content within the particular device is detected. In another embodiment, a record corresponding to the content within the particular device is also detected.

In Block 730, a synchronization program is selected. In one embodiment, the synchronization program is selected by the particular device. For example, the particular device actively selects a synchronization program or relies on a default synchronization program. In another embodiment, the synchronization program is selected by the second device.

In one embodiment, the synchronization program is stored within the particular device. In another embodiment, the synchronization program is stored within the second device.

In one embodiment, the synchronization program sets criteria for determining which content is to be transferred from the second device to the particular device. In one embodiment, the synchronization program sets criteria for determining which content is to be transferred from the particular device to the second device.

For instance, an exemplary synchronization program instructs the second device to transmit “newest” content to the particular device. In this embodiment, “newest” content refers to content that has been least utilized or least played by the particular device. In another embodiment, an exemplary synchronization program instructs the second device to transmit a favorite content list to the particular device. In yet another embodiment, an exemplary synchronization program instructs the second device to transmit new content that is not currently stored within the particular device. In yet an additional embodiment, an exemplary synchronization program instructs the second device to transmit random content to the particular device.

In Block 740, content is selected for transmission to the particular device. In one embodiment, the content is selected based on the synchronization program selected in the Block 730.

In Block 750, a format is selected for the content that is to be transmitted to the particular device based on specific criteria. For example, if the storage device of the particular device lacks sufficient capacity to store the selected content to be transmitted to the particular, a lower resolution format is utilized for the selected content. In another embodiment, if the particular device is capable of utilizing content at a predetermined resolution, a format having a resolution equal to the predetermined resolution is utilized for the selected content.

In Block 760, content that is stored within the particular device and is new to the second device is transmitted to the second device. In another embodiment, records associated with the content transmitted to the second device is also transmitted to the second device from the particular device.

In Block 770, the selected content as identified in the Block 740 is transmitted to the particular device from the second device.

In one embodiment, the flow diagram in FIG. 7 describes a scenario wherein a portable audio player receives content from a media server. In one embodiment, the portable audio player requests audio content from the media server based on the synchronization program.

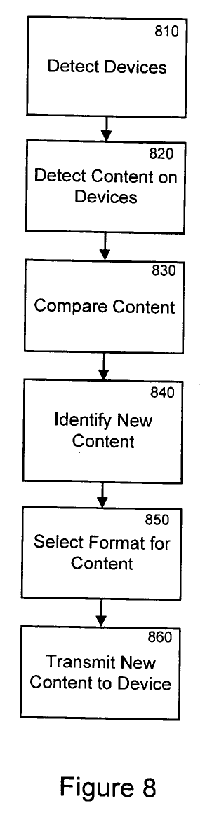

The flow diagram in FIG. 8 illustrates a specific example of synchronizing content among multiple devices according to one embodiment of the invention. In Block 810, a first device and a second device that are seeking synchronization are detected. In one embodiment, the first device contain content. In another embodiment, both the first device and the second device contain content.

In one embodiment, the first device is a content player and is capable of storing content and playing content such as a portable audio player, a video player, and the like. In another embodiment, the second device is a media server configured to store and stream content.

In Block 820, the content within the first and second devices are detected. In another embodiment, records corresponding to the content within the first and second devices are also detected.

In Block 830, the content and the records within the first and second devices are compared. In one embodiment, the review module 310 compares the content and corresponding records.

In Block 840, new content that is not found on both the first device and the second device is identified. For example, if content is found on the first device and not on the second device, this content is identified as new content for the second device. Similarly, if content is found on both the first device and the second device, this content is identified as existing content for both the first device and the second device.

In Block 850, a format is selected for content that is to be transmitted to the particular device based on specific criteria. In one embodiment, if the storage device of the particular device lacks sufficient capacity to store the selected content to be transmitted to the particular, a lower resolution format is utilized for the selected content. In another embodiment, if the particular device is capable of utilizing content at a predetermined resolution, a format having a resolution equal to the predetermined resolution is utilized for the selected content. In yet another embodiment, the particular device communicates with the second device through a connection. If this connection supports limited bandwidth, then an appropriate format is selected for transmitting content.

In Block 860, the new content as identified in the Block 840 is transmitted to each respective device. For example, the new content stored on the first device is transmitted to the second device. Similarly, the new content stored on the second device is transmitted to the first device.

In one embodiment, the flow diagram in FIG. 8 describes a scenario wherein two media servers wish to synchronize their content with each other. In one embodiment, the media servers automatically receive new content in an appropriate format depending on the media server.

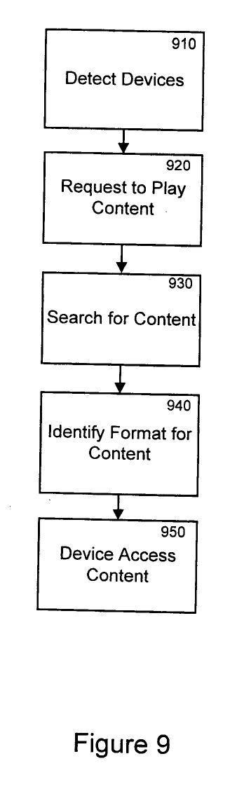

The flow diagram in FIG. 9 illustrates a specific example of finding content among multiple devices according to one embodiment of the invention.

In Block 910, a first device and a second device are detected. In one embodiment, the first device is seeking content contained within the second device. In another embodiment, both the first device is seeking content in other devices.

In one embodiment, the first device is a content player and is capable of storing content and playing content such as a portable audio player, a video player, and the like. In another embodiment, the second device is a media server configured to store and stream content.

In Block 920, a first device requests to play a particular piece of content. For example, the first device requests to store and play a particular sonq that is not stored within the first device.

In Block 930, a search is performed the particular content that is identified in the Block 920. In one embodiment, the particular content is searched for within the second device. In another embodiment, other devices are accessed are queried for the particular piece of content.

In Block 940, a format is identified for the particular content. In one embodiment, the first device is examined. In one instance, the storage capacity of the first device is determined. In another instance, the ability of the first device to utilize various formats is determined.

In one embodiment, the format of the particular content is determined based on the storage capacity of the first device. For example, if the storage capacity of the first device is such that content having more information than the MP3 format would exceed the storage capacity of the first device, then the particular content would be formatted to MP3 standards.

In another embodiment, the format of the particular content is determined based on the ability of the first device. For example, if the first device is only able to utilize content formatted in the MP3 standard, the particular content is formatted in the MP3 standard.

In one embodiment, the particular content is stored in the second device in multiple formats as duplicate copies. When a particular format is identified, the appropriate copy of the particular content matching the identified format is utilized. In another embodiment, the highest resolution format of the particular content is stored in the second device. When a particular format is identified, the highest resolution format of the particular content is formatted into the identified format within the second device.

In Block 950, the particular content is transmitted from the second device to the first device and is available to the first device.

In one embodiment, the flow diagram in FIG. 9 describes a scenario wherein a device searches for duplicate content from multiple devices. In one embodiment, the device automatically receives the content in an appropriate format.

The foregoing descriptions of specific embodiments of the invention have been presented for purposes of illustration and description. The invention may be applied to a variety of other applications.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A method comprising:
receiving a request for a specific content from a first device;
identifying the specific content within a second device;
selecting a format for the specific content based on the first device; and
transmitting the specific content in the format from the second device to the first device.

2. The method according to claim 1 further comprising transforming the specific content into the format.

3. The method according to claim 1 wherein selecting the format further comprises detecting a storage capacity of the first device.

4. The method according to claim 1 wherein selecting the format further comprises detecting a play capability of the first device.

5. The method according to claim 1 wherein selecting the format further comprises detecting a connection between the first device and the second device.

6. The method according to claim 1 wherein the specific content includes one of a song, an album, and a video.

7. The method according to claim 1 further comprising storing the specific content within the first device.

8. The method according to claim 1 wherein the first device is an audio device.

9. The method according to claim 8 wherein the audio device is a portable audio player.

10. The method according to claim 1 wherein the second device is a media server.

11. The method according to claim 1 wherein the format is an MP3 format.

12. A system comprising:
means for receiving a request for a specific content from a first device;
means for identifying the specific content within a second device;
means for selecting a format for the specific content based on the first device; and
means for transmitting the specific content in the format from the second device to the first device.

13. A method comprising:
detecting content within a second device;
selecting a synchronization program;
selecting a format based on a first device; and
automatically transmitting the content to the first device in the format based on the synchronization program.

14. The method according to claim 13 wherein the content includes one of a song, an album, and a video.

15. The method according to claim 13 wherein the synchronization program identifies new content for transmission to the first device.

16. The method according to claim 13 wherein the synchronization program identifies random content for transmission to the first device.

17. The method according to claim 13 wherein the synchronization program identifies favorite content for transmission to the first device.

18. A system, comprising:
an interface module configured for receiving a request specifying content and detecting a device;
a storage module configured for storing the content; and
a review module configured for identifying the content and formatting the content based on the device.

19. The system according to claim 18 further comprising a capture module configured to identify the content.

20. The system according to claim 18 wherein the content includes one of a song, an album, and a video.

21. The system according to claim 18 wherein the review module is configured to apply a synchronization program in identifying the content.

22. The system according to claim 18 wherein the storage module is configured to store a record corresponding to the content.

23. The system according to claim 18 wherein the storage module is configured to store a synchronization program.

24. A computer-readable medium having computer executable instructions for performing a method comprising:
detecting content within a second device;
selecting a synchronization program;
selecting a format based on a first device; and
automatically transmitting the content to the first device in the format based on the synchronization program.
